(19) United States
(12) Patent Application Publication
(10) Pub. No.: US 2010/0192201 A1
(43) Pub. Date: Jul. 29, 2010

(54) Method and Apparatus for Excessive Access Rate Detection

(75) Inventors: Asaf Shimoni, Herzliya (IL); Galit Efron-Nitzan, Herzliya (IL); Ofer Shezaf, Herzliya (IL); Rami Mizrahi, Herzliya (IL)

Correspondence Address: PROCOPIO, CORY, HARGREAVES & SAVITCH LLP, 525 B STREET, SUITE 2200, SAN DIEGO, CA, 92101, US

(73) Assignee: Breach Security, Inc., Carlsbad, CA (US)

(21) Appl. No.: 12/697,049

(22) Filed: Jan. 29, 2010

Related U.S. Application Data
(60) Provisional application No. 61/148,321, filed on Jan. 29, 2009.

(51) Int. Cl. G06F 21/20

(52) U.S. Cl. 726/3

(57) ABSTRACT

A system and method for protection of Web based applications are described. Anomalous traffic can be identified by comparing the traffic to a profile of acceptable user traffic when interacting with the application. Excessive access rates are one type of anomalous traffic that is detected by monitoring a source and determining whether the number of requests that the source generates within a specific time frame is above a threshold. The anomalous traffic, or security events, identified at the individual computer networks are communicated to a central security manager. The central security manager correlates the security events at the individual computer networks to determine if there is an enterprise wide security threat. The central security manager can then communicate instructions to the individual computer networks so as to provide an enterprise wide solution to the threat. Various responsive actions may be taken in response to detection of an excessive access rate.

### RELATED APPLICATIONS

This application claims the benefit of U.S. Provisional Patent Application Ser. No. 61/148,321, filed Jan. 29, 2009, entitled “A METHOD AND APPARATUS FOR EXCESSIVE ACCESS RATE DETECTION,” which is hereby incorporated by reference in its entirety.

### FIELD OF THE INVENTION

This invention relates to computer network security, and more particularly preventing Web application threats.

### BACKGROUND

Recent, well publicized, security breaches have highlighted the need for improved security techniques to protect consumer privacy and secure digital assets. Examples of organizational victims of cybercrime include well known companies that typically have traditional Web security in place, yet cyber criminals have still been able to obtain personal data from financial, healthcare, retail, and academic Web sites.

Organizations can not afford negative brand image, credibility damage, legal consequences, or customers losses. The disclosure of some of these Web security breaches has led law enforcement to determine, after careful investigation, that cybercrime is in some instances being driven by organized crime that can dedicate significant resources toward attempting to circumvent security systems. Targeted rings of well educated and sophisticated hackers have been uncovered, often in countries where prosecuting them is a challenge. Contributing to the increase in cybercrime is the ease with which these organized cyber criminals can target, and hack, a Web application from anywhere in the world with simple Internet access.

Properly securing Web applications and the data behind them is a critical component to doing business on the Web. Often, some of the most valuable organizational data is served through a Web browser making it more important than ever to safeguard this information from cybercriminals.

Thus, there is a need for improved systems and techniques to protect Web applications from security breaches.

### SUMMARY

Techniques for preventing attacks of Web based, or network based, applications are described. In one embodiment, excessive access rates are detected by monitoring a source and determining whether the number of requests that the source generates within a specific time frame is above a threshold. A source may be identified based on session ID, user name, IP address, or a combination of session IDs with user name and/or IP address. If the number of requests that the source generates within a specific time frame is above a threshold, the source may be classified as automated and blocked from accessing information during further requests.

In an embodiment, a computer-implemented method for securing a web server is provided. The method includes the steps of receiving a request to access content on a web server, identifying a source of the request, incrementing a request total associated with the source representing a number of requests received from the source during a predetermined time interval, determining whether the request total exceeds an access threshold associated with the content, and performing a responsive action if the request total exceeds the access threshold.

In another embodiment, an application security system is provided. The application security system includes a processor and a computer-readable storage medium communicatively coupled with the processor and storing computer-executable instructions. The computer-executable instructions include an application protection module configured to perform the following steps: receiving a request to access content on a web server, identifying a source of the request, incrementing a request total associated with the source representing a number of requests received from the source during a predetermined time interval, incrementing a request total associated with the source representing a number of requests received from the source during a predetermined time interval, determining whether the request total exceeds an access threshold associated with the content, and performing a responsive action if the request total exceeds the access threshold.

According to yet another embodiment, a computer-readable medium comprising processor-executable instructions that, when executed, direct a computer system to perform actions as set of actions is provided. The actions include: receiving a request to access content on a web server, identifying a source of the request, incrementing a request total associated with the source representing a number of requests received from the source during a predetermined time interval, incrementing a request total associated with the source representing a number of requests received from the source during a predetermined time interval, determining whether the request total exceeds an access threshold associated with the content, and performing a responsive action if the request total exceeds the access threshold.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an example system configured according to an embodiment;

FIG. 2 is a block diagram illustrating aspects of an example embodiment of a Web application protection system which can be carried out by the Web application protection module of FIG. 1 according to an embodiment;

FIG. 3 is a block diagram of illustrating further detail of an example dataflow in a Web application security technique as may be performed by the Web application protection module of FIG. 1;

FIG. 4 is an example display, generated by the management console, designed to enable application security management according to an embodiment;

FIG. 5 is a display of an example policy manager display generated by the manager console according to an embodiment;

FIG. 6 is a display of an example event viewer display generated by the manager console according to an embodiment;

FIG. 7 is a flow chart illustrating an example technique for detecting excessive access rates and blocking requests exceeding allowable access rates according to an embodiment;

FIGS. 8A and 8B are block diagrams illustrating a rolling time window for determining whether a request has exceeded excessive access rates according to an embodiment; and

FIG. 9 is a flow chart illustrating another example technique for detecting excessive access rates and blocking requests exceeding allowable access rates according to an embodiment.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

Need for Increased Security

Government regulations for privacy and accountability mandate that there be a standard of security and customer notification if personal data is lost or stolen. For example, in the United States, many states have enacted a form of the Information Security Breach Act and other states have similar pending privacy legislation. Organizations are also motivated by consumer expectations to incorporate security measures to safeguard data. Some industries, such as the credit card industry, have enacted their own data security standards. However, the number of data security and notifications laws informing consumers of data breaches is likely to increase. Therefore, organizations are motivated to improve and validate existing security measures that protect the organization from Web threats and to demonstrate to regulators and stakeholders that security is interwoven into the business operations.

Shortcomings in Existing Security Measures

The growth of the Internet as a network for commerce and communications has been unprecedented. However, security was not part of the original design of the Internet, leaving Web applications susceptible to security breaches. The rapid expansion of the use of the Internet has also led many organizations to migrate applications to the Internet that were originally designed for use on internal network environments. The internal network environments were typically run on networks and servers protected by firewalls and intrusion detection systems. A cyber-criminal would have to circumvent these protections in order to access sensitive data stored on servers within in internal network environment. As Web-based applications have evolved, hackers have shifted their focus to targeted attacks on these applications. Often these applications provide a front-end to an organization's mission critical data. Hackers no longer need to search for sensitive data on the organizations network and can instead simply browse the organization's web site to identify sensitive data.

A common misconception in Web security is that using Secure Sockets Layer (SSL) will protect a Web application from attacks. While SSL supports secure transmission of sensitive information, but SSL does not protect a Web application from attack. SSL merely product protection of data during transmission. Attacks can be sent using SSL and the SSL transmission goes through firewalls because the firewall will usually have a port, typically port 443, open to permit SSL traffic. For example, SQL Injection attacks (described in detail below) can circumvent network security because the SQL commands used in the attack can be transmitted to the web application using SSL.

Conventional application protection solutions or application firewalls followed the same paradigm as network firewalls where a negative or list-based model of application level threats is used to screen for potential application-level attacks. But, the negative model is generally not effective in securing Web-based applications from attack since each Web based application is unique and has unique security concerns. One approach was to create a tailored application security profile for each application, but this approach can be too cumbersome and time consuming, particularly in a production environment where multiple web applications may be deployed.

Furthermore, many conventional application protection solutions are configured to be an in-line device. Being an in-line device, the solutions have to ensure that there is no, or minimal, impact to production network operations, including considerations such as traffic latency, the introduction of false positives, and the potential to block a valid transaction.

Example Aspects of a Web Application Security System

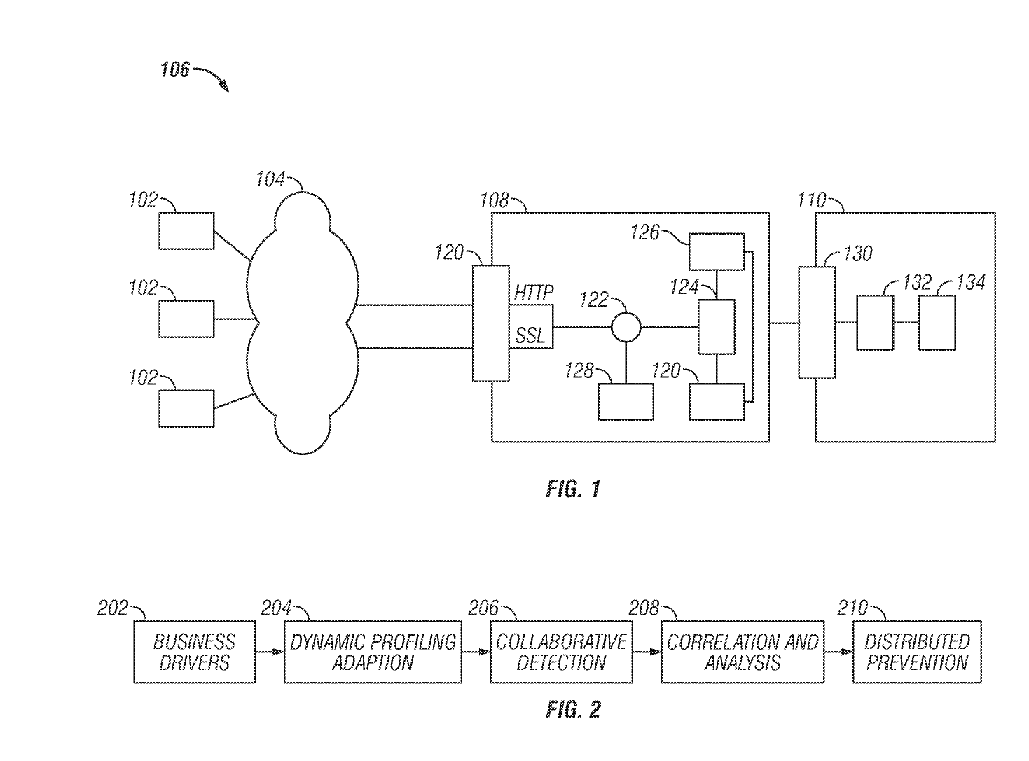

FIG. 1 is a block diagram of an example web application security system configured in accordance with aspects of the invention. As shown in FIG. 1 users 102 are in communication with a wide area network 104. The wide area network 104 may be a private network, a public network, a wired network, a wireless network, or any combination of the above, including the Internet. Also in communication is a computer network 106. A typical computer network 106 may include two network portions, a so called demilitarized zone (DMZ) 108, and a second infrastructure network 110. The DMZ 108 is usually located between the wide area network 104 and the infrastructure network 110 to provide additional protection to information and data contained in the infrastructure network 110.

For example, the infrastructure network 110 may include confidential and private information about a corporation, and the corporation wants to ensure that the security and integrity of this information is maintained. However, the corporation may host a web site and may also desire to interface with users 102 of the wide area network 104. For example, the corporation may be engaged in e-commerce and wants to use the wide area network 104 to distribute information about products that are available to customers, and receive orders from customers. The interface to the wide area network 104, which is generally more susceptible to attacks from cyber-criminals is through the DMZ 108, while sensitive data, such as customer credit card information and the like, are maintained in the infrastructure network 110 which is buffered from the wide area network 104 by the DMZ 108.

Examples of components in a DMZ 108 include a firewall 120 that interfaces the DMZ 108 to the wide area network 104. Data transmitted and received from the wide area network 104 pass through the firewall 120, through a mirror port 122 to a load balancer 124 that controls the flow of traffic to Wed servers 126. Also connected to the mirror port 122 is a Web application protection module 128. As described further below, the Web application protection module 128 monitors traffic entering and leaving the DMZ to detect if the Web site is being attacked.

Traffic flows between the DMZ 108 and the infrastructure network 110 through a second firewall 130 that provides additional security to the infrastructure network 110. Components in the infrastructure network 110 can include an application server 132 and a database server 134. Data and information on the application server 132 and database server 134 are provided additional protection from attacks because of the operation of the DMZ.

Security Model to Protect Web Applications

Typically, network-level devices use a negative security model or “allow all unless an attack is identified.” Network-level devices such as Intrusion Detection and Prevention Systems are effective with this generic negative model because network installations are common across organizations. However, every Web application is different and a generic or “one-size-fits-all” model for security generally will not work satisfactorily.

A positive, behavior-based security model is generally more effective in securing Web applications. Because each Web application is unique, they expose their own individual sets of vulnerabilities that need to be addressed. A positive behavior-based security model provides protection against threats that are outside the bounds of appropriate, or expected, behavior. Because the security model monitors behavior to determine if it is appropriate, the model can provide protection against unforeseen threats.

To implement a positive, behavior-based security model, a tailored application security profile is created that defines appropriate application behavior. While a unique security profile is needed for every Web application, manual creation of these profiles may be overly burdensome. Instead, it would be beneficial to create security profiles automatically for each application. In addition, it would be beneficial to automate profile maintenance which ensures that application changes are incorporated into the profile on an on-going basis.

As noted, Web applications expose a new set of vulnerabilities that can only be properly understood within the context of the particular application. For example, SQL injection attacks are only valid in applications that take user input. Likewise, forceful browsing attempts can only be determined by understanding the interplay of all the scripts and components that make up the Web application. Further, session manipulation techniques can only be identified by understanding the session mechanism implemented by the application.

To effectively protect a Web application requires understanding how the application works. Thus, generic protection mechanisms, such as those provided by network security devices, are typically inadequate due to a high rate of false positives or attacks missed entirely due to a lack of understanding of where exploitable vulnerabilities are exposed within a specific application.

Exemplary Embodiments of Web Application Security

In one embodiment of the Web application security system, protection techniques are adapted to address the unique security challenges inherent in Web applications. The techniques fill holes in network-level security, provides tailored application-specific security, and comprehensive protection against an array of potential Web-based threats.

The techniques include combining a behavioral protection model with a set of collaborative detection modules that includes multiple threat detection engines to provide security analysis within the specific context of the Web application. In addition, the techniques reduce the manual overhead encountered in configuring a behavioral model, based upon a profile of typical or appropriate interaction with the application by a user, by automating the process of creating and updating this profile. Further, the techniques include a robust management console for ease of setup and management of Web application security. The management console allows security professionals to setup an application profile, analyze events, and tune protective measures. In addition, the management console can provide security reports for management, security professionals and application developers.

The techniques described further below, allow organizations to implement strong application-level security using the same model that is currently used to deploy the applications themselves. The techniques include additional advantages over other technologies by not requiring an inline network deployment. For example, the techniques have minimal impact on network operations because they can be deployed off of a span port or network tap and does not introduce another point of failure or latency to network traffic.

While the techniques described are not implemented inline, they can prevent attacks against Web applications by interoperating with existing network infrastructure devices, such as firewalls, load balancers, security information management (SIM) and security event management (SEM) tools. Because Web application attacks are typically targeted, and may require reconnaissance, the techniques are adapted to block attacks from a hacker, or cyber-criminal, before they are able to gather enough information to launch a successful targeted attack. Various techniques may be combined, or associated, to be able to identify and correlate events that show an attacker is researching the site, thereby giving organizations the power to see and block sophisticated targeted attacks on the application.

Some of the advantages provided by the techniques described include protecting privileged information, data, trade secrets, and other intellectual property. The techniques fill gaps in network security that were not designed to prevent targeted application level attacks. In addition, the techniques dynamically generate, and automatically maintain, application profiles tailored to each Web application. The techniques can also provide passive SSL decryption from threat analysis without terminating an SSL session.

The techniques can also provide flexible distributed protection based upon a distributed detect/prevention architecture (DDPA). Additional protection of customer data is provided by exit control techniques that detect information leakage. A graphical user interface (GUI) can provide detailed event analysis results as well as provide detailed and summary level reports that may be used for compliance and audit reports. Use of various combinations of these techniques can provide comprehensive protection against known, as well as unknown, Web threats.

FIG. 2 is a block diagram illustrating aspects of an example embodiment of a Web application protection system which can be carried out by the Web application protection module 128 in FIG. 1. As shown in FIG. 2, a business driver module 202 provides input about the types of threats that are anticipated, and that protection against is sought, or the types of audits or regulations that an entity wants to comply with. Examples of threats include identity theft, information leakage, corporate embarrassment, and others. Regulatory compliance can include SOX, HIPAA, Basel LL, GLBA, and industry standards can include PCI/CISP, OWASP, and others. The business driver module 202 provides input to a dynamic profiling module 204.

The dynamic profiling module 204 develops profiles of Web applications. The profiles can take into account the business drivers. The profiles can also be adapted as Web applications are used and user's behavior is monitored so that abnormal behavior may be identified. The profiles can also be adapted to identify what types of user input is considered appropriate, or acceptable. Dynamic profiling module 204 provides input to a collaborative detection module 206.

The collaborative detection module 206 uses the input from the dynamic profiling module 204 to detect attacks against a Web application. The collaborative detection module can monitor, and model, a user's behavior to identify abnormal behavior of a user accessing a Web application. The collaborative detection module 206 can also monitor user activity to identify signatures of attack patterns for known vulnerabilities in a Web application. Other aspects include protection against protocol violations, session manipulation, usage analysis to determine if a site is being examined by a potential attacker, monitoring out bound traffic, or exit control, as well as other types of attack such as XML virus, parameter tampering, data theft, and denial of services attacks. The collaborative detection module 206 provides the results of its detection to a correlation and analysis module 208.

The correlation and analysis module 208 receives the detection results from the collaborative detection module 206 and performs event analysis. The correlation and analysis module 208 analyses events reported by the collaborative detection module 206 to determine if an attack is taking place. The correlation and analysis module 208 can also correlate incoming requests from users with outgoing response to detect if there is application defacement or malicious content modification being performed. The correlation and analysis module may establish a severity level of an attack based upon a combined severity of individual detections. For example, if there is some abnormal behavior and some protocol violations, each of which by itself may set a low severity level, the combination may raise the severity level indicating that there is an increased possibility of an attack. The output of the correlation and analysis module 208 is provided to a distributed prevention module 210.

The distributed prevention module 210 provides a sliding scale of responsive actions depending on the type and severity of attack. Examples of responses by the distribution prevention module 210 include monitor only, TCP-resets, load-balancer, session-blocking, firewall IP blocking, logging users out, and full blocking with a web server agent. The distribution prevention module 210 can also include alert mechanisms that provide event information to network and security management systems through SNMP and syslog, as well an email and console alerts.

Using the dynamic profiling module 204, collaborative detection module 206, correlation and analysis module 208, and distributed prevention module 210 security for a Web application can be provided. Improved Web application security provides protection of privileged information, increased customer trust and confidence, audit compliance, increased business integrity, and brand production.

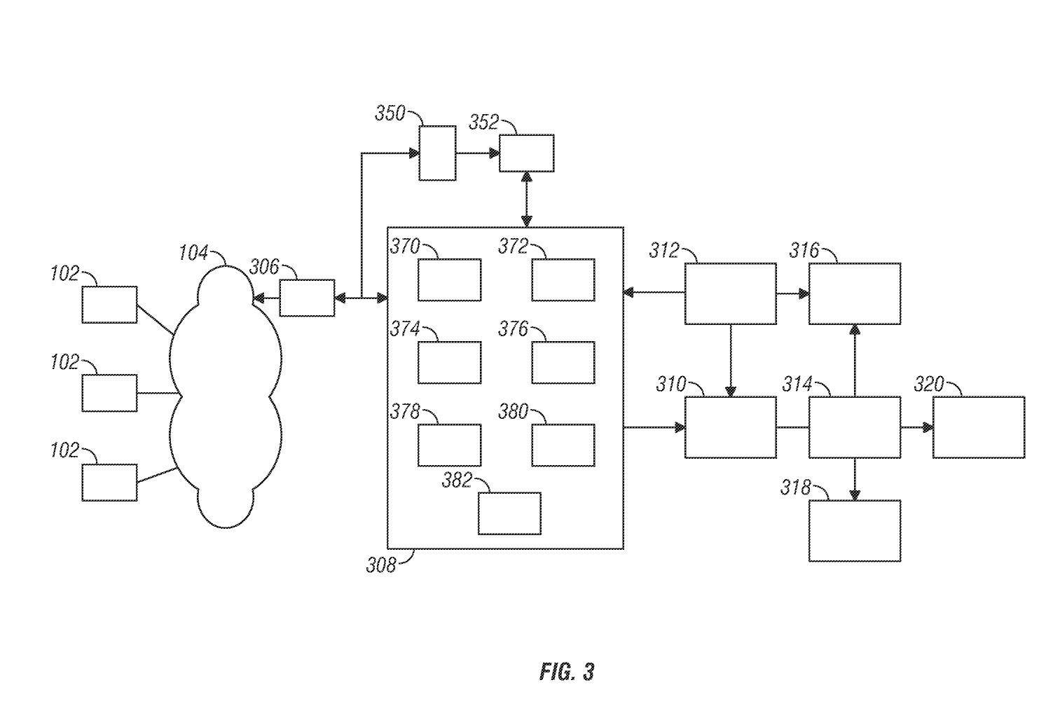

FIG. 3 is a block diagram of illustrating further detail of an example dataflow in a Web application security technique as may be performed by the Web application protection module 128 of FIG. 1. As illustrated in FIG. 3 multiple users 102 are in communication with a wide area network 104, such as the Internet. The users may desire to access a Web application. Typically, a user will access a Web application with web traffic using SSL encryption. A SSL decryption module 306 can passively decrypt the traffic to allow visibility into any embedded threats in the web traffic. The web traffic then flows to a collaborative detection module 308 where the traffic is analyzed in the context of appropriate application behavior compared to the applications' security profile. If an anomaly is discovered, it is passed to one or more of the multiple threat-detection engines included within the collaborative detection module 308. The results from the collaborative detection module 308 are communicated to an Advanced Correlation Engine (ACE) 310 where it is determined the threat context and to reduce false positives. In addition, the collaborative detection module 308 monitors outbound traffic as well as inbound traffic to prevent data leakage such as Identity Theft.

Collaborative Detection Module

The following discussion provides additional detail of the collaborative detection module 308 illustrated in FIG. 3. As noted in the discussion of FIG. 3, web traffic flows to the collaborative detection module 308 where the traffic is analyzed. The traffic is analyzed by a behavior analysis engine 370 in the context of appropriate application behavior compared to the applications' security profile. If an anomaly is discovered the traffic is passed to one or more of the multiple threat-detection engines included within the collaborative detection module 308. The multiple threat-detection engines work synergistically to deliver comprehensive Web application protection that spans a broad range of potentially vulnerable areas. By working together the multiple threat-detection engines are able to uncover threats by analyzing them in the context of the acceptable application behavior, known Web attack vectors and other targeted Web application reconnaissance.

Behavioral Analysis Engine

The behavioral analysis engine 370 provides positive validation of all application traffic against a profile of acceptable behavior. A security profile of acceptable application behavior is created and maintained by the adaption module 350 which monitors Web traffic and continually updates and tunes a security profile module 352 that maintains the security profiles of applications. A security profile of an application maps all levels of application behavior including HTTP protocol usage, all URL requests and corresponding responses, session management, and input validation parameters for every point of user interaction. All anomalous traffic identified by the behavioral analysis engine 370 is passed to one or more threat detection engines to identify any attacks and provide responsive actions. This ensures protection from all known and unknown attacks against Web applications.

Signature Analysis Engine

One threat detection engine in the collaborative detection module 308 can be a signature analysis engine 372. The signature analysis engine 372 provides a database of attack patterns, or signatures, for known vulnerabilities in various Web applications. These signatures identify known attacks that are launched against a Web application or any of its components. Signature analysis provides a security context for the anomalies detected by the behavioral analysis engine 370. When attacks are identified they can be ranked by severity and can be responded to with preventative actions. This aspect of the Web application security system provides protection from known attacks against Web applications, Web servers, application servers, middleware components and scripts, and the like.

A signature is a combination of terms and conditions, that when fully met define a security issue or other meaningful event (e.g. server technology). Examples of main terms and conditions include patterns and their way of appearance in different contexts of the request/reply. For example, matching a request-reply pair for a specific signature is one technique of specifying that terms and conditions defining a signature where met by a request-reply pair.

Signatures may also be based on matching predetermined patterns against data, at specified locations, in the request-reply pair. For example, matching a pattern for “onclick” against request content. The patterns can be either a simple pattern (i.e. a string) or a regular expression. In general, pattern matching technology may be less efficient when matching regular expression as opposed to matching simple patterns. Therefore, it is usually preferred to use simple pattern over regular expression.

Following are examples of locations within the request-reply pair where signature patterns can be matched against: (1) URL, (2) a normalized URL; (3) parameters value; (4) request normalized parameters names; (5) request normalized parameters values; (6) request headers values; (7) request headers names; (8) request specific header (with provided name); (9) request content; (10) reply content; (11) reply HTML title; and (12) cookies (OTB).

In one embodiment, a signature can be composed of matching one or more patterns with various relations. For example, a relation may be that all patterns should appear, X out of Y patterns should appear, a distance between patterns should be Z, etc. Search technologies can include: (1) Simple pattern/s match—pattern/s that appear in the requested location. Each pattern is configured with a separate location. No special relations between the patterns are required; (2) Complex Pattern search—Complex Pattern is a sequence of patterns with relations of words skip or characters skip between them. One example of word skip is to search for patterns that appear with the specified number of words between them. An example search would be for a pattern of “SQL” and “error” with a work skip equal to 1.

In the example the string “SQL syntax error” matches the search, while the string “SQL error” does not match. Search patterns can also be setup where the number of words between search terms can be up to a desired number. For example, a search can be for “SQL” and “error” with a word skip value of “up to 1.” In this case both the string “SQL syntax error” and the string “SQL error” match this search. It is noted that a word may be a sequence of characters. The characters that can be included in a word are configurable. The default characters are (a-z, A-Z, 0-9). Another example of a search pattern includes characters skip-patterns where a number of characters between appearances of selected characters can be specified up to a desired value.

Word boundary is another type of search pattern. In this type of search there is a match of the pattern only if its requested boundaries are not alphanumeric (a-z, A-Z, 0-9). In addition, the search can specify whether it is referring to the left boundary, the right boundary, both or either. There can also be a weighted search. In a weighted search a list of complex patterns can be specified such that at least a predefined number of patterns should appear in order to have a match.

When a signature is matched, a signature basic event may be issued with a parameter indicating the signature type. Examples of basic events that are “signature basic event” (SBE), include one for a request signature and another for a reply signature. These event parameters can be included in the signature id. The SBE is generally available for the correlation engine.

In one example the signature analysis engine support signature updates. Examples of signature updates include the following: (1) add new signature, (2) remove an existing signature; and (3) change an existing signature definition.

Examples of signature definitions include the following: (1) Identifier—unique id; (2) Severity; (3) Type (Security Signature, Server Technology etc.); (4) Request/Reply Signature; (5) List of patterns and for each its following attributes: (a) Pattern string or regex (if type is regex); (b) Pattern name (can be “bogus” identifier); (c) Patterns type (regular/regular expression); (d) Pattern sequential number; (e) the location in which the patterns should be searched in; (f) whether should check pattern for its boundaries; (g) Whether the pattern must appear or must not appear (i.e. pattern or NOT (pattern)); (6) Definition of Complex Patterns; (7) Weighted Search definition; and (8) Extracted data information.

As noted, a Complex Pattern is a sequence of patterns with relations of words skip or characters skip between them. Examples of various skip relations include: (1) Words skip relation—the relation specifying the number of words that should appear between two numbers; (2) “Up To” words skip relation—specifying that the number of words between the appearances of the provided patterns should be up to the provided number; and (3) “Up To” Characters Skip—specifying that the number of characters between the appearances of the provided patterns should be up to the provided matter.

Signature configuration can also include extracted data information. In a typical example the extracted data information includes two items: (1) Regular expression representing the data that can be extracted from the request/reply; and (2). Search Location: the location that the provided regular expression should be matched against. The matching can be done either from the first appearance found in that location or from the beginning of the location as will be set in the HLD.

An example of the operation of the Signature Analysis Engine is described. Upon startup signatures are loaded from a definition file and updated in a signature database. Upon initialization the following may be done: (1) delete signature: a signature that exist in the database and is not included in the current definition file is deleted; (2) add Signature: a signature that does not exist in the database and is included in the current definition file is added; and (3) update signature: a signature that exists both in the signature database and in the current HML definition file is checked to see whether its definition should be changed. The signature analysis engine can then check the request/reply for signature matches. In one example the signature matching itself may be done according to the following phases: (1) Use the search module (patterns manager) for the search of all specified patterns for all signatures; (2) Only if one or more of the patterns is found, process the results; (3) For each signature, add an appropriate event (SBE) in case the signature is matched.

A signature basic event file can include the following: (1) Id: SIGNATURE; (2) Short Description: “Signature was detected at the request*”; (3) Long Description: “The signature % SIGNATURE-NAME % was detected at the request*”; (4) Change Detection flag: off; (5) Policy Element (for update profile rule): NONE; (6) CE Key: % PARAM_VALUE(SIGNATURE, SIGNATURE_ID) %; (7) Security Event Flag: true. It is noted that in a reply signature basic event the word “request” should be replaced with the word “reply”.

Protocol Violation Engine

The collaborative detection module 308 can include a threat detection engine referred to as a protocol violation engine 374. The protocol violation engine 374 protects against attacks that exploit the HTTP and HTTPS protocols to attack Web applications. Web traffic is analyzed by the behavioral analysis engine 370 to ensure that all communication with the application is in compliance with the HTTP and HTTPS protocol definitions as defined by the IETF RFCs. If the behavioral analysis engine 370 determines that there is an anomaly, then the traffic is analyzed by the protocol violation engine 374 to determine the type and severity of the protocol violation. The protocol violation engine 374 provides protection against attacks using the HTTP protocol, for example, denial of service and automated worms.

Session Manipulation Analysis Engine

Another threat-detection engine that can be included in the collaborative detection module 308 is a session manipulation analysis engine 376. Session manipulation attacks are often difficult to detect and can be very dangerous because cyber-criminals, such as hackers, impersonate legitimate users and access functionality and privacy data only intended for a legitimate user. By maintaining all current user session information, it is possible to detect any attacks manipulating or hijacking user sessions, including session hijacking, hidden field manipulations, cookie hijacking, cookie poisoning and cookie tampering. For example, a state tree of all user connections may be maintained, and if a connection associated with one of the currently tracked user's session jumps to another user's session object, a session manipulation event may be triggered.

In an embodiment, session manipulation analysis engine 376 can perform passive session tracking where a predefined list of regular expressions that can identify session IDs in requests and replies is defined. A generation process will choose a subset of these session ID definitions as the ones that are used to identify sessions. These session IDs will be searched for in all requests and replies. The session IDs will be extracted from the request using a combination of the request's objects (such as cookies, parameters, etc), and general regular expressions that are used to extract specific session data. Each set of regular expressions defines which part of the request it runs on, and can be used to extract a value and optionally extract up to two names. In addition, if the regular expression is being searched for in the URL, it can also extract the indexes of an expression that needs to be removed from it. Regular Expression Sets can have one of the following types: (1) Param: Includes two regular expressions. One is searched for in the parameter name, and the other in its value; (2) WholeCookie: includes two regular expressions, one is searched for in the cookie name, and the other in its value (the entire cookie value, without additional parsing); (3) CookieParam: includes three regular expressions, and works on cookies that have been separated correctly into names and values, the first expression is on the cookie's name, the second—on the cookie's parameter name, and the third on the cookie parameter's value. (for example, in the cookie header: “Cookie: mydata=lang=heb|sessionid=900” the cookie's name is “mydata”, the two parameters are “lang” (with the value “heb”) and “sessionid” (with the value 900)); (4) SemiQuery: includes one regular expression that is run on the query that comes after a semicolon (for example, in the URL “/a.asp;$jsessionid$123”, the regular expression will run on the underlined part). (5) NormURL: this regular expression runs on the normalized URL and may return indexes, in which case the part of the URL that is between these indexes is removed—this is done to support sessions that are sent as part of the URL but should not be included in the URL when it is learnt by the ALS; (6) Header: includes two regular expressions, one is searched for in the header name, and the other in its value.

Advanced Correlation Engine

In one embodiment, the ACE 310 includes a first input adapted to receive threat-detection results and to correlate the results to determine if there is a threat pattern. The ACE 310 also includes a second input adapted to receive security policies and to determine an appropriate response if there is a threat pattern. The ACE also includes an output adapted to provide correlation results to an event database 314. The correlation engine examines all of the reference events generated by the detection engines. This can be viewed as combining positive (behavior engine/adaption) and negative security models (signature database) with other specific aspects to web application taken into account (session, protocol). As an example consider a typical SQL Injection, at least one if not two behavioral violations will be detected (invalid characters and length range exceeded) and several signature hits may occur (SQL Injection (Single quote and equals) and SQL Injection (SELECT Statement)). Any one of these events on their own will typically be a false positive, but when correlated together, they may provide a high likelihood of an actual attack.

Another example of the correlation engine is seen when the security system is deployed in monitor only mode and an actual attack is launched against the web application. In this example, the security system will correlate the ExitControl engine events (outbound analysis) with the inbound attacks to determine that they were successful and escalate the severity of the alerting/response.

If the ACE 310 confirms a threat, then the security policy for the application, which is provided by a security policy module 312, is checked to determine the appropriate responsive action. The ACE 310 may also communicate its results to the event database 314 where the ACE results are stored. The event database 314 may also be in communication with a distributive detect prevent architecture (DDPA) module 316.

A security policy, or “Policy”, defines a configuration of the security system's detection and prevention capabilities for a specific site. A policy defines the attacks and information leakage the system will look for while analyzing traffic and what response actions to take should something be detected. A policy may be specific implementation of a general security policy of the organization or enterprise as it relates to a specific web application. A policy can be defined per application, or it can be defined per site. In one embodiment, a policy contains “BreachMarks” and security events which may be presented to a user in a tree structure that contains groups and sub-groups that organize the security events for the user to view. Users will see in the BreachMarks group all available BreachMarks in the system—there is no list per site, a user simple chooses which BreachMarks to enable for this policy.

In one embodiment a Policy can specify the following configurations. For Inbound Events (Attacks): (1) enable/disable; and (2) actions to take for successful attacks, unsuccessful attacks, attempted attacks, and for information leakage. For Outbound Events (Leakage): (1) enable/disable; and (2) action or actions to be performed upon detection of the data leakage. For BreachMarks: (1) whether the data matching a specified BreachMark is to be masked (i.e., obfuscated) in the logs, in events sent to the logs, and/or in reports; and (2) actions to be taken by the security system in response to an event. The security system can take various actions, including: (1) logging events—event information is written to a database that is accessible by the EventViewer that can display event information; (2) Simple Network Management Protocol (“SNMP”) alerts—an SNMP trap can be set that allows the a SNMP message to be generated upon the occurrence of a specified event; (3) reset—a TCP reset can be sent; and (4) block—the attacker can be blocked at the firewall. It is noted that logging an event, or any other desired action, can be the default action for an event that does not have any action identified (e.g. new event, event that was previously disabled).

In one embodiment, a single Policy can be applied to a specific site. In addition, specific policy may be applied to multiple sites. If an “applied” policy is updated, it will remain “applied”, and the updates will take effect in all sites. Users may create custom BreachMarks to define patterns for sensitive information within their organization. In addition a number of pre-defined policies providing configurations tuned to specific vertical markets and levels of acceptable risk can be provided to the user. A “standard policy” can be setup to serve as the default policy. In the event that a user does not “assign” a policy to an application, this default policy can be used. Also, standard policies may be updated and the updates can be distributed to the user. Further, users may create their own custom policies by modifying pre-defined policies in the Policy Manager.

Policies can be imported and exported thereby allowing users to copy policies from one system to another. Typically the security policy module 312 will be responsible for the following tasks: (1) loading/updating a policy from a database, (2) loading/saving policies from/into the database, (3) loading/saving sites-policies associated from/into a configuration file, (4) loading/saving sites-policies association from/into the database, (5) updating relevant components on configuration changes, and (6) performing the configured action in response to a correlated event.

When detecting security events, the policy module 312 receives notification on detected events. Upon receipt of a security event, the policy module 312 checks what responsive action should be taken. When there has been an event the policy module 312 enables signatures that participate in the newly enabled security events. In addition, the policy module 312 may disable signatures that participate only in recently disabled security events. To accomplish this, the policy module 312 determines which signatures are participating in the newly enabled security events and then requests the signatures to add them.

As shown in FIG. 3, the responsive action may be provided to the DDPA module 316 by the security policy module 312. The DDPA module 316 may also receive information from the ACE 310 via the event database 314. The DDPA module 316 may, for example, alert, log, or block a threat by coordinating distributed blocking with a network component, not shown, such as a firewall, Web server. or Security Information Manager (SIM).

The event database 314 may also be in communication with an event viewer 318, such as a terminal, thereby providing information about events to a network administrator. The event database 314 can also communicate input to a report generating module 320 that generates reports about the various events detected.

Adaption Module

An adaption module 350 monitors Web traffic and continually updates and tunes a security profile module 352 that maintains security profiles of applications. The updated security profiles are communicated to the collaborative detection module 308 so that a current security profile for an application is used to determine if there is a threat to the application. Following is a more in-depth description of aspects and features of the Web application security techniques.

Management Console

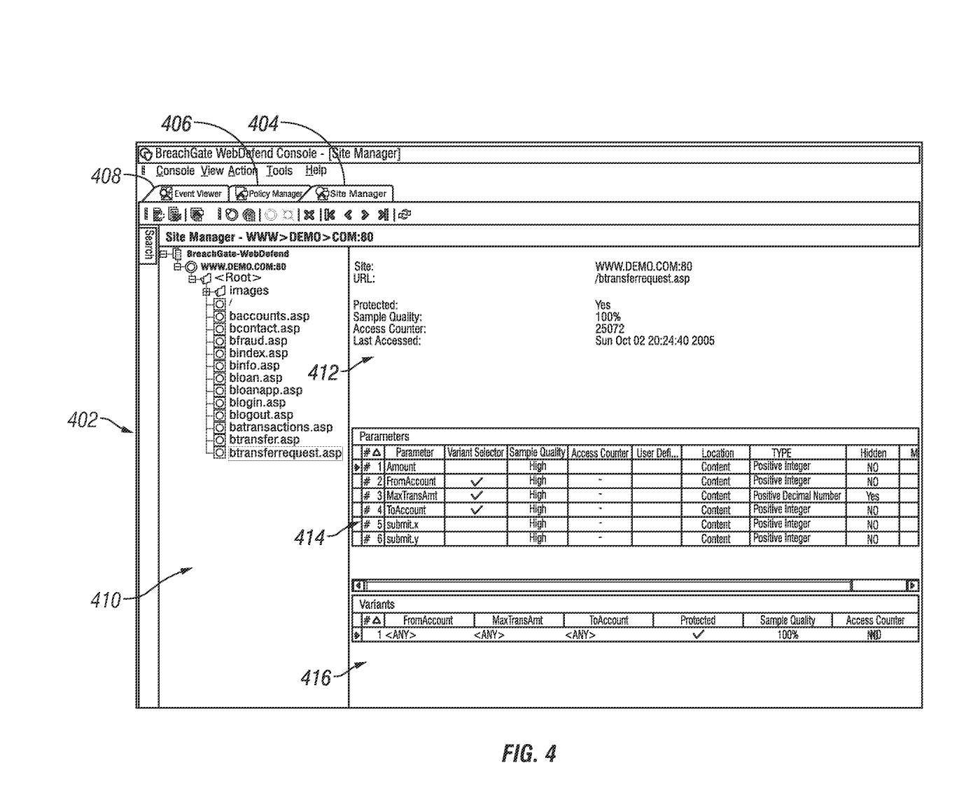

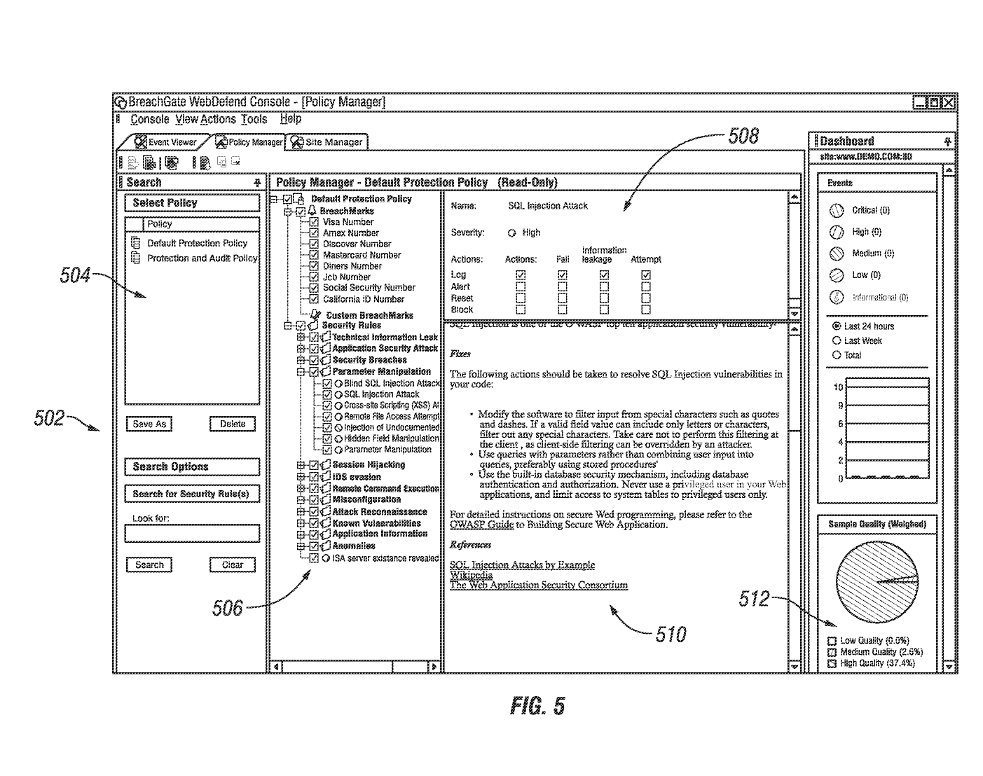

A management console can be used to generate displays of information to a network administrator on an event viewer 318 of FIG. 3. FIG. 4 is an example display 402, generated by the management console, designed to enable intuitive application security management. As shown in FIG. 4, the display 402 generated by the management console can include tabs for a site manager 404, a policy manage 406, and an event viewer 408. In FIG. 4, the site manager tab 404 has been selected. The site manager display 404, generated by the management console, provides a user interface for interacting with an application's profile, as developed and stored in the adaption modules 350 and application profile 352 of FIG. 3. The site manager display 404 depicts an application's security profile or model in a hierarchical tree structure. Nodes on the tree represent URL's within the application profile.

The site manager display 404 can also include a directory window 410 allowing the network administrator to navigate through the application profile. The directory window 410 can be a site map organized in a hierarchy to provide an intuitive interface into the organizational structure of the web application.

The site manager display 404 also includes a status window 412 where information about the status of the Web application protection system is displayed. The Status Window 412 can display the status of the attack detection engines and performance and access statistics.

There is also a parameters window 414 where the status of various parameters of the Web application protection system is displayed. The parameter window 414 can list each user entry field or query in the selected URL. Each parameter entry includes the quality of the statistical sample size for this field, validation rules for determining the correct behavior of user entries in the field, and other characteristics.

The site manager display 404 can also include a variants window 416 where information about variants that are detected can be displayed. The variant window 416 can list the response pages possible through various valid combinations of user parameters selected in the request. For example, if a page had a list of products that a user could select, the page would have variants for each different possible product in the list. Variants include information used to uniquely identify the response page.

FIG. 5 is an example policy manager display 502 generated by the management console. Within the Web application security system, a policy describes the configuration options for the detection engines as well as what responsive action to take when an event is detected. A policy lists the security events that the Web application security system will monitor and the responsive action to be taken if the event is detected. The policy manager display 502 enables administrators to view and configure security policies for a Web application security system, such as the policies stored in the security policy module 312 of FIG. 3. For example, the policy manager display 502 can provide a list of events organized into categories within a tree structure. Each event may be enabled or disabled and responsive actions for each event can be configured such as logging the event, sending a TCP Reset or firewall blocking command, or setting an SNMP trap.

Policies can be standard, out-of-the-box, policies that are configured to provide different levels of protection. Administrators can modify these standard policies in the Policy Manager to create application-specific policies. In addition, administrators can design their own policy from scratch.

The Web application security system can include special patterns, referred to as BreachMarks, which are used to detect sensitive information such as social security numbers or customer numbers in outgoing Web traffic. The BreachMarks, which can be included in the security policies, can be customized to a particular data element that is sensitive to an enterprise's business. BreachMarks allow organizations to monitor and block traffic leaving the organization which contains patterns of data known to represent privileged internal information.

The policy manager display 502 can be used to define and manage the configuration of the Web application security system mechanisms and includes the ability to fine-tune threat responses on a granular level. As shown in FIG. 5, the policy manager display includes a policy window 504 where a network administrator can select a desired policy for use by the Web application security system. The policy manager display 502 also includes a navigation window 506 so that different types of security issues can be tracked and monitored. There is also a policy modification window 508 that allows an administrator to set various responses to a security attack. In the example of FIG. 5, the administrator is able to set how the Web application security system will respond to an SQL injection attack. The policy display 502 also includes a recommendation window, where suggestions for how to modify a network's operation to better prevent attacks are provided. There is also a dashboard window 512 that provides the administrator summary information about the types and severity of various events identified by the Web application security system.

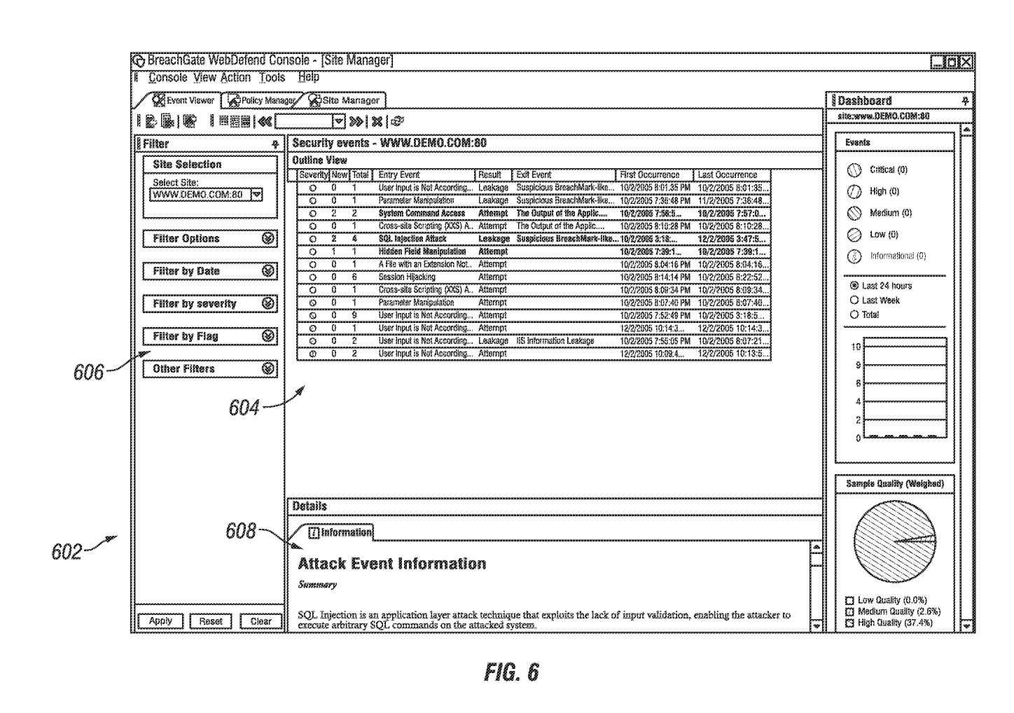

FIG. 6 is an example event viewer display 602, generated by the management console, as might be displayed on the event viewer 318 of FIG. 3. Within the Web application security system, the event viewer display 602 console can include a real-time event analysis module. The event viewer display 602 includes an event detection window 604 with a list of events detected by the Web application security system. This list may include the date, the URL affected, and names both the entry event for the incoming attack as well as any exit event detected in the server's response to the attack.

In section 606, each selected event may be described in detail, including an event description, event summary, and detailed information including threat implications, fix information, and references for more research. In addition, the event viewer may provide administrators a listing of the reference events reported by the detection engines to determine this event has taken place, the actual HTTP request sent by the user and reply sent by the application, as well as a browser view of the response page. This detailed information allows administrators to understand and verify the anomaly determination made by the various detection engines.

The event viewer display 602 can also include a filter window 606 where an administrator can setup various filters for how events are displayed in the event description window 604. There is also a detail description window 606 where detailed attack information is provided to the administrator. The event filter display 602 may include filters for date and time ranges, event severity, user event classifications, source IP address, user session, and URL affected.

Returning to FIG. 3, the Web application security system can also provide a full range of reports 320 for network administrators, management, security professionals, and developers about various aspects of the security of a Web application. For example, reports can provide information about the number and types of attacks made against corporate Web applications. In addition, reports can include information with lists of attacks and techniques to assist in preventing them from occurring again. Also, application developers can be provided reports detailing security defects found in their applications with specific recommendations and instructions on how to address them.

Usage Analysis Engine

Still another threat detection engine that can be included in the collaborative detection module 308 is a usage analysis engine 378. The usage analysis engine 378 provides analysis of groups of events looking for patterns that may indicate that a site is being examined by a potential attacker. Targeted Web application attacks often require cyber-criminals to research a site looking for vulnerabilities to exploit. The usage analysis engine 378, over time and user sessions, can provide protection against a targeted attack by uncovering that a site is being researched, before the site is attacked. The usage analysis engine 378 correlates events over a user session to determine if a dangerous pattern of usage is taking place. An example of this analysis is detecting a number of low severity events resulting from a malicious user probing user entry fields with special characters and keywords to see how the application responds. These events may not raise any alarms on their own but when seen together may reveal a pattern of usage that is malicious. Another example of this analysis is detecting brute force login attempts by correlating failed login attempts and determining that threshold has been reached and thus, the user may be maliciously trying to guess passwords or launching a dictionary attack of password guesses at the web application. Another example of this analysis is detecting scans by security tools when an abnormal amount of requests are received in the same session. Yet another example of this analysis is detecting http flood denial of service attacks when an abnormal number of duplicate requests are received in the same session. This analysis can be easily extended to detect distributed denial of service attacks by boot networks correlating multiple individual denial of service attacks.

Exit Control Engine

Yet another threat detection engine that can be included in the collaborative detection module 308 is an exit control engine 380. The exit control engine 380 provides outbound-analysis of an application's communications. While incoming traffic is checked for attacks, outgoing traffic may be analyzed as well. This outgoing analysis provides essential insight into any sensitive information leaving an organization, for example, any identity theft, information leakage, success of any incoming attacks, as well as possible Web site defacements when an application's responses do not match what is expected from the profile. For example, outgoing traffic may be checked to determine if it includes data with patterns that match sensitive data, such as a nine digit number, like a social security number, or data that matches a pattern for credit numbers, drivers license numbers, birth dates, etc. In another example, an application's response to a request can be checked to determine whether or not it matches the profile's variant characteristics.

Web Services Analysis Engine

Another threat detection engine that can be included in the collaborative detection module 308 is a Web services analysis engine 382. The Web services analysis engine 382 provides protection for Web Services that may be vulnerable to many of the same type of attacks as other Web applications. The Web services analysis engine 382 provides protection from attacks against Web services such as XML viruses, parameter tampering, data theft and denial of Web services attacks.

Threats detected by any of the above threat detection engines in the collaborative detection module 308 may be communicated to the advanced correlation engine 310 where they are analyzed in context of other events. This analysis helps to reduce false positives, prioritize successful attacks, and provide indications of security defects detected in the application. In one embodiment, the advanced correlation engine 310 can be based upon a positive security model, where a user's behavior is compared with what is acceptable. In another embodiment, the advanced correlation engine 310 can be based upon a negative security model, where a user's behavior is compared to what is unacceptable. In yet another embodiment, the advanced correlation engine 310 can be based upon both models. For example, the user's behavior can be compared with what is acceptable behavior, a positive model, and if the behavior does not match known acceptable behavior, then the user's behavior is compared with what is known to be unacceptable behavior, a negative model.

Example Embodiments

Embodiments of the Web application protection system can be used to prevent various types of attacks targeting Web applications, such as SQL injection attacks, session hijacking, and excessive access rate attacks. SQL injection attacks exploit security vulnerabilities in the database layer of Web applications by fooling an application into accepting a string from the user that includes both data and database commands where a string containing just data is expected. Session hijacking attacks focus on weaknesses in the implementation of session mechanisms used in Web applications. Attackers can manipulate these mechanisms to impersonate legitimate users in order to access sensitive account information and functionality. Excessive access rate attacks deluge a Web site or Web server with a large number of requests in a short period of time in order to negatively impact the performance of the Web site. Techniques for preventing SQL injection and session hijacking attacks are described in related U.S. patent application Ser. No. 11/532,060, which is herein incorporated by reference in its entirety, and techniques for detecting and blocking excessive access rate attacks are described below. According to an embodiment, the Web application protection system can detect and prevent multiple types of attacks simultaneously.

Detecting Excessive Access Rate

An excessive access rate is a condition where a single source is issuing a large number of requests in a short period of time. An excessive access rate usually implies that an automated program, such as a web robot is targeting the web site. While an automated program may be innocent, in many cases such automated programs deliberately or inadvertently causes damage to the web site that being targeted. Some examples of the damage that an automated program can cause to a web site are: (1) performing a denial of service attack that harms a web site's responsiveness; (2) performing a brute force attack in order to determine users' passwords; (3) consuming extra bandwidth, which may incur financial costs on a web site owner; (4) performing a security scan and trying to locate security vulnerabilities in the web application; (5) potentially exploiting a previously discovered loophole in order to steal large quantities of sensitive information from the web site, for example, using blind SQL injection; (6) mirroring a web site or portions thereof, driving traffic to the mirrored information and potentially violating the web site's usage agreement; and (7) abusing the web site's functionality, for example, by automatically bidding at an auction site or by playing multiple coordinated players in a casino.

In contrast, some web robots do not cause harm and can provide value to a website. A good example of a beneficial web robot is a search engine robot that indexes web sites and enables users to find the web site when searching the Internet. Web site administrators may want to allow web robots providing beneficial services to access the site while blocking others that may cause damage to the website.

Excessive access rates may be detected by monitoring each source (e.g., a single source IP address, a single user or a single session) and determining whether the number of requests that the source generates within a specific time frame is above a threshold. In an exemplary embodiment, excessive access rate methods described herein are implemented in the application protection module 128.

It should be appreciated that the excessive access rate methods described herein may be implemented by in-line or out-of-line devices. Monitoring excessive access rates protects against attacks that exploit the HTTP and HTTPS protocols to attack Web applications.

In addition, the threshold for number of requests within a specific time frame can be profiled by dynamic profiling adaption module 204 so that this threshold is dynamic. For example, if the access threshold number is set at 10 requests within the time frame of 1 minute for a protected web site, and a source is detected that accessed the web site more than 10 times a minute, the source will be considered as “automated” and the module 128 can send a message to the server receiving the requests (e.g., application server 132 in FIG. 1). In response to that message, the server can take action (e.g., TCP reset, alert, or blocking). If the same user is making multiple requests during a short period of time, the user can be logged out by the Web application protection system and/or may be denied future access to the website or network being protected.

The first step in detecting an excessive access rate is identifying the source to monitor. The identity of a source is based on characteristics of the source. For example, sources may be identified based on session ID, user name, IP address, a combination of session IDs with user name and/or IP address, etc. In an embodiment, regardless of how a source is identified, adaption module 350 monitors Web traffic and maintains a profile of each source, how the source has been identified, and monitors the access rate of the source.

Security profile module 352 also preferably includes information such as the number of requests for a specific time frame threshold for each type of source. These thresholds may be set by a network administrator and changed based on need or desirability or can be profiled dynamically. By comparing the information in security profile 352 and the Web traffic being monitored by adaption module 350, abnormal behavior is identifiable.

In identifying a source based on session ID, single users in an application are monitored because of the nature of requiring the users to login to a session. Session IDs may be monitored as described above using Passive Session Tracking by the use of, for example, cookies. The Adaption process, as performed in block 350 of FIG. 3, can automatically identify methods of implementing session management in Web applications. Use of session ID is attractive because the session ID has a relatively short implementation time (e.g., less than one month).

However, not all excessive access rates are session dependent (i.e., require login). Furthermore, if a source is logging into multiple sessions and sending a single request after login, because each session does not exceed the access rate threshold, this multiple session login activity may go undetected. Alternatively, in one embodiment, a source is identified based on user name. In a preferred embodiment, user name is used in addition to session ID to identify a source. User name tracking is similarly performed by adaption module 350.

An advantage of a session ID and user name solution is that session ID and user name is a strong identifier in any application and the multiple session login problem described above is resolved. Furthermore, the session ID and user name solution may be implemented in two stages, such that the user name may be considered a secondary session ID. For example, establishment of a session may include authenticating a user with an authentication means. Such authentication means may be a user name or password or any other authentication.

In a preferred embodiment, the user name is used for authentication. In user name tracking, when users are redirected to another site (e.g., after login, users are typically redirected to another site), enhancements may be desired to ensure proper operation. Additionally, further support for user name tracking, such as for NT LAN Manager (“NTLM”), authentication and logout may be desired.

Alternatively, in another embodiment, a source is identified based on the IP address. Using the IP address has the advantage that a wider range of attacks may be detected (e.g., accesses to resources per IP, events such as mini-multi request correlation (e.g., the number of events over the events from the same source)) and that attacks that are not login/session dependent may be detected. Once the source is set as an IP address in security profile 352, adaption module 350 performs IP address tracking by monitoring Web traffic.

However, IP address tracking may be prone to proxy issues and additional measures such as maintaining a white list may be desired. Additionally, in some instances, IP address tracking may need to be implemented as a module separate from session tracking.

Alternatively, in some embodiments, a source is identified by a combination of session ID and/or user name and/or IP address. Such a technique is referred to as a global approach and may require implementation in a separate module.

Once the source is identified and tracked, if the number of requests within a specific time frame threshold is exceeded, the source may be blocked from accessing information during further requests. Additionally, multiple thresholds can be used by various request counts and time periods. For example, in some instances it may be desirable to monitor and block many requests over a short period of time, e.g., 100 requests a minute. In other instances it may be desirable to monitor and block more persistent requests, e.g., 10,000 requests a week.

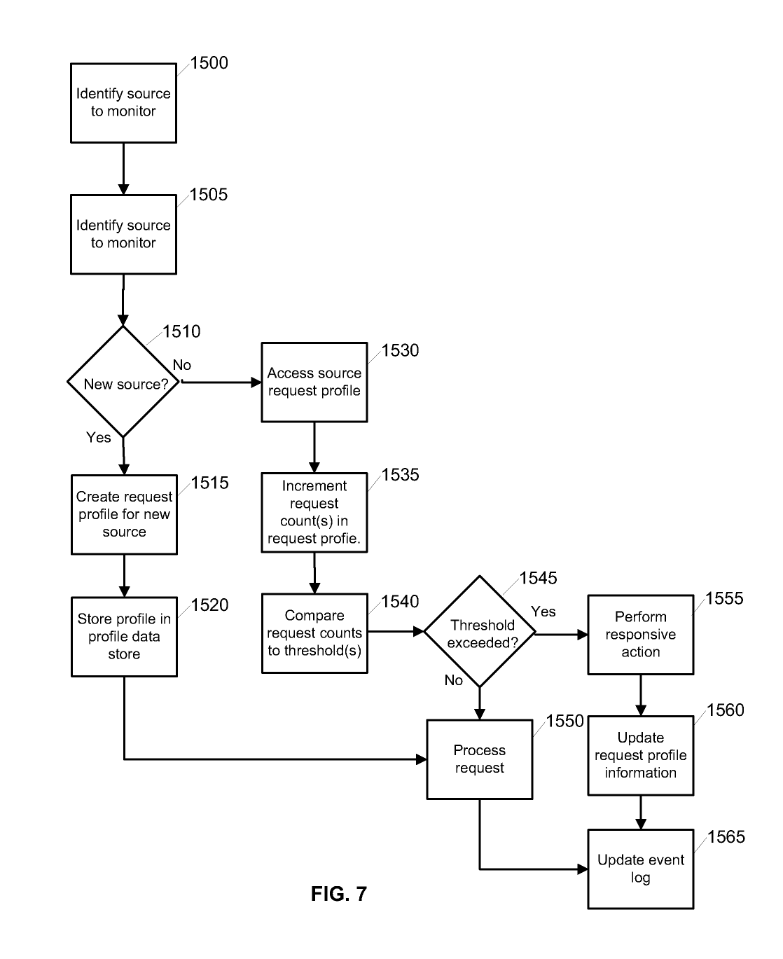

FIG. 7 is a flow diagram of a technique for identifying excessive access rate events and for responding to such events according to an embodiment. In an embodiment, the technique illustrated in FIG. 7 can be implemented in application protection module 128. A request is received (step 1500) and a source of the request is identified (step 1505). The source of the request is identified so that the number of requests originating from the source can be monitored. The source can be identified using any of the various techniques described above, such as the IP address of the source or a user name associated with the source. In an embodiment, the source is identified by adaption module 350.

Once the source has been identified, a determination is made whether the source has a request profile associated with the source. The request profile tracks the number of requests that the source has made over a predetermined time frame. The request profile can be used to identify excessive access rate events by comparing the request profile for the source to one or more thresholds used to determine whether an excessive access rate event has occurred. According to an embodiment, adaption module 350 maintains the request profile for each source. A source may already have a request profile associated with the source if a request has been previously received from the source.

If the source does not have a request profile, a request profile is created for the source (step 1515), and the request profile for the source is stored (step 1520). According to an embodiment, the request profile is created and stored by adaption module 350. In the embodiment illustrated in FIG. 7, if the source does not have a request profile when the request from the source is received, the source has not yet exceeded any access rate thresholds that may have been created for the security system. However, if subsequent requests from the same source are received, the request profile for the source can be examined to see if the source has exceeded any request thresholds. The request received from the source is then processed (step 1550). According to an embodiment, the security profile module 352 maintains threshold information for each type of source, and may also maintain threshold information for specific sources. Excessive access rates events can be identified by comparing the threshold information maintained by the security profile module 352 with the request profile for the source maintained by the adaption module 350. According to an embodiment, the security policy module 312 maintains a security profile that defines a set of one or more responsive actions to be taken in response to a threshold being exceeded.

If a request profile exists for the source, the request profile is accessed (step 1530). The request profile can include information about the number and types of requests that a source has made. For example, in an embodiment, the request profile can include the URL of a web page requested, the number of requests that have been received for that web page from the source, and the period of time over which the requests have been received. The number of requests received from the source is incremented in the request profile associated with the source (step 1535). According to an embodiment, the adaption module 350 increments the number of requests received from the source in the request profile associated with the source, and stores the updated request profile.

The number of requests made by the source is then compared request threshold limits to determine whether the number of requests received from the source exceed a threshold (step 1540). An administrator can define various thresholds. For example, a threshold may be defined that limits the number of requests that may be received from a single source within a predetermined period of time. In another embodiment, a threshold may be associated with specific content and the number of requests received from a particular source for the specified content cannot exceed predetermined threshold. For example, an administrator may define a threshold associated with a login page for a web application where a specified source cannot exceed 10 requests to access the logic page per minute. If the number of requests for the login page exceeds this threshold, the requests exceeding the threshold may be blocked and/or another responsive action may be performed. For example, a user can be logged out of the system, an alert can be generated for an administrator, subsequent requests from the user or from the user's IP address can be blocked, and/or other actions may be performed in response to the threshold being exceeded.

According to some embodiments, a threshold may be related to multiple pieces of content. For example, a threshold may be related to a group of web pages associated with a monitored web site. When a group of pages is being monitored, the rate at which requests for each web page in the group may be adjusted. For example, if two web pages from the same website are being monitored, the threshold for blocking a request may be decreased for each of the pages such that a fewer number of visits from the same source (e.g., one half the threshold for the number of visits to the monitored web pages) trigger the requests from the source to be blocked. According to an embodiment, different content may be assigned different threshold values. For example, a web page where a login or sign in is requirement may be treated differently than other web page. In one embodiment, a login page may have a lower threshold value for triggering the blocking of subsequent requests from the same source in order to prevent malicious users or web robots from using brute force attacks to try to access protected content and to prevent denial of service attacks on the system by flooding the web site with requests for the login page in order to prevent other legitimate users from being able to access the website.

A determination is then made whether the number of requests made by the source is then compared request threshold limits to determine whether the number of requests received from the source exceed a threshold (step 1545). If the request did not exceed a threshold value, the request from the source is processed (step 1550). For example, the request may be forwarded to the web server to access content referenced in the request. According to an embodiment, the receipt and/or processing of the event may be added to the event database 314 (step 1565). Events added to the event database 314 can be viewed using event viewer 318.

If a threshold was exceeded, then a responsive action is performed (step 1555). As described above, the security policy module 312, is checked to determine the appropriate responsive action to perform in the event that the threshold is exceeded. In an embodiment, the request received from the source is blocked to prevent the request from receiving the web server. The request profile may be updated to indicate that request has been blocked for exceeding a threshold and/or another responsive action has been performed (step 1560). The event database 314 may also be updated to indicate that the request received from the source was blocked because an excessive number of requests were received within a predetermined period of time (step 1565). Information related to the request, such as the source of the request, the requested action or content, the date and/or time that the data was requested, and the reason that the request was blocked may be included in the entry in the event database. Event viewer 318 can be used to view event data, and an administrator can view information about which requests were blocked using the event viewer 318. In one embodiment, an administrator may configure the system to block and/or log excessive access rate events by selecting an “excessive access rate” detection folder within navigation window 506 of the policy window 504.

According to an embodiment, the time frame used to determine whether a threshold has been exceeded includes two components: a plurality of incremental time windows and rolling time window. The rolling time window includes the plurality of incremental time windows and may be described as rolling because the rolling time window is constantly dropping off the oldest incremental time windows and including the newest incremental time windows such that a set duration of time (e.g., the time frame) is constantly monitored. Thus, the number of requests received in a time frame is determined by adding up all of the requests for each of the incremental time windows within the rolling time window.

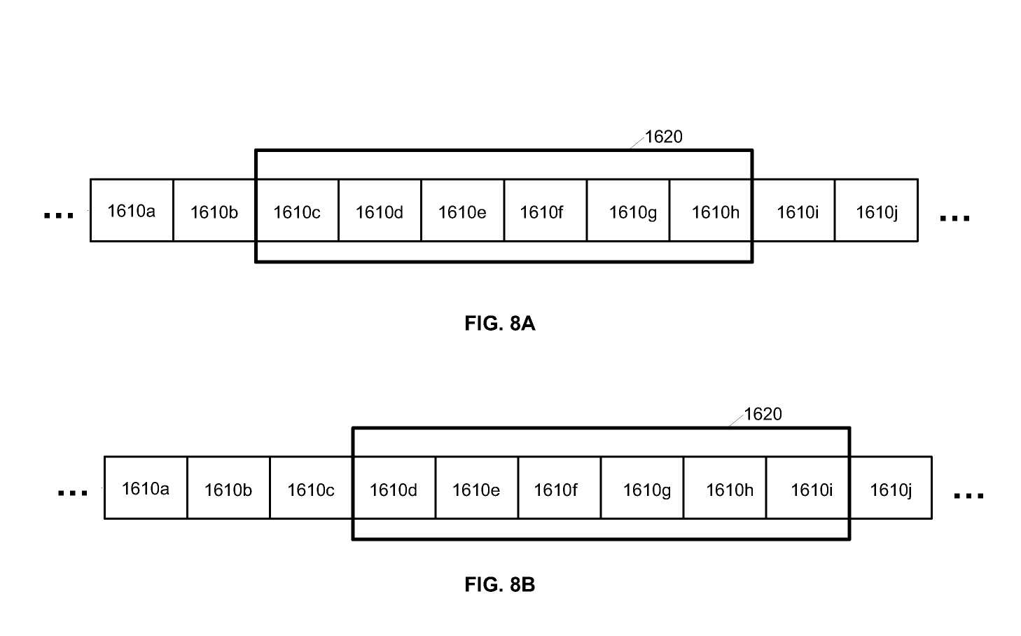

FIGS. 8A and 8B are block diagrams illustrating a rolling time window 1620 for determining whether a request has exceeded excessive access rates according to an embodiment. FIGS. 8A and 8B illustrate a period of time during which requests from a source are being monitored. The period of time is divided into a multiple incremental time windows 1610a-1610j. Each incremental time window can be described as a short-duration time window. During each incremental time window, the number of requests received from a source are added up, and stored in a request total associated with that incremental time window in the request profile associated with the source. The duration of the incremental time windows can vary from embodiment to embodiment, and in some embodiments, an administrator can configure the duration of the incremental time windows. For example, an administrator may use policy window 504 to configure the length of the incremental time windows.

FIG. 8A illustrates the rolling time window 1620 at a first increment of time and FIG. 8B illustrates the rolling time window 1620 at a second increment of time. The rolling time window can be described as rolling because the rolling time window continually drops off the oldest of the incremental time windows included in the incremental time window and adds a next sequential incremental time window to the rolling time window such that a set duration of time (e.g., the time frame) is constantly monitored. The rolling time window 1620 progresses from left to right. For example, in the embodiments illustrated in FIGS. 8A and 8B, the rolling time window 1620 includes six incremental time windows. In FIG. 8A, the rolling time window 1620 includes a first set of incremental time windows 1610c-1610h, and FIG. 8B illustrates the rolling time window 1620 at a second time increment where rolling time window includes a second set of incremental time windows 1610d-1610i.

To determine whether the number of requests has exceeded a threshold, the number of requests received during each of the incremental time windows included in the rolling window is summed to determine a current request total. For example, in FIG. 8A, the number of requests received during incremental time windows 1610c-1610h are added up to determine a current request total, and in FIG. 8B, the number of requests received during incremental time windows 1610d-1610i are added up to determine the current request total. The current request total determined using this technique is then used compared to threshold information to determine whether the

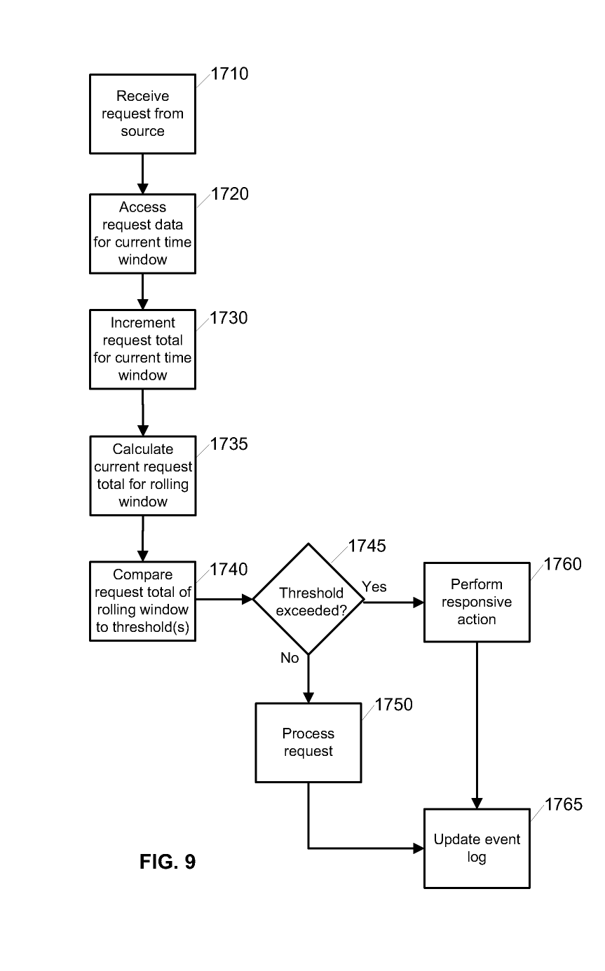

FIG. 9 is a flow diagram of a technique for identifying excessive access rate events and for responding to excessive access rate events using a rolling access window according to an embodiment. A request is received for a particular source (step 1710), and the data associated with the current incremental time window is accessed (step 1720). The request totals for the current incremental time window is incremented (step 1730). The current request total for the rolling window is calculated (step 1735) by summing the incremental time windows included in the rolling window.

A determination is made whether a threshold is exceeded by the current request total (step 1740). If a threshold is exceeded, the request from the source is blocked and/or another responsive action has been performed (step 1760). The event log may then be updated to indicate that the request from the source has been blocked and/or another responsive action has been performed (1765). Otherwise, if a threshold was not exceeded, the request from the source is processed (step 1750) is processed, and the event log may be updated to indicate that the request from the source has been processed (1765).

In an exemplary embodiment, the automated sources may be blocked using various blocking options in policy window 504. For example, an administrator may configure the security system to block requests from a source if an excessive access rate is detected and/or to log excessive access rate events. In one embodiment, an administrator may configure the system to block and/or log excessive access rate events by selecting an “excessive access rate” detection folder within navigation window 506 of the policy window 504. As an example, because automated source detection is based on source IP, the source IP may be blocked on a firewall such as firewall 120.

In an embodiment, the default setting is to block excessive access rate events. However, the administrator may override the default setting and configure the system to only log excessive access rate events or to both detect and log the excessive access rate events. Other additional options may also be included according to other embodiments of the present invention.

An event viewer display 602 similar to that show in FIG. 6 can be provided to review event logs in order to view events related to excessive access rate events. The event viewer display 602 may include an option for displaying only blocked events and events that were logged but not blocked in separate listing to allow an administrator to more easily identify events that were blocks versus events that logged but not blocked. For example, event viewer display may include an option to view “sources with an excessive access violation” that allows the administrator to view information about blocked requests from sources that have been blocked due to excessive access rate violations.

As presented above, the excessive access rate techniques described herein may be implemented in the application protection module 128. As discussed in an earlier section with reference to FIG. 3, application protection module 128 may include an Advanced Correlation Engine (ACE) 310. In one embodiment, the ACE 310 includes a first input adapted to receive threat-detection results and to correlate the results to determine if there is a threat pattern. The ACE 310 also includes a second input adapted to receive security policies and to determine an appropriate response if there is a threat pattern. The ACE also includes an output adapted to provide correlation results to an event database 314. The correlation engine examines all of the reference events generated by the detection engines. This can be viewed as combining positive (behavior engine/adaption) and negative security models (signature database) with other specific aspects to web application taken into account (session, protocol). Thus, ACE 310 takes multiple variables into account in providing correlation results to event database 314. In one embodiment, a watch list, such as a list of sources which have not been blocked, but have been making requests to a monitored web site, is maintained. If, for example, one of the multiple variables ACE 310 is monitoring changes with respect to a source saved in the watch list, ACE 310 may provide information to event database 314 to generate a flag and block the source.

Additional anti-automated solutions may also be implemented in policy window 504, which assist in preventing access to automated programs. For example, Complete Automated Public Turing test to tell Computers and Humans Apart (“CAPTCHA”) technology may be used, which presents users with an image of distorted, obscured letters and requires them to type those letters before they are allowed to continue. Because the text is obscured, it prevents common robots using simple character recognition programs from decoding the image into letters and proceeding. While CAPTCHAs are effective against common robots, they make it more difficult for a user to use an application and therefore are usually limited to very sensitive actions. Additionally, targeted robots using advanced algorithms may now be able to defeat CAPTCHAs. Therefore, it is preferable to use CAPTCHA in addition to the blocking options described above. Additionally, while CAPTCHAs have been described as useful in assisting to prevent access to automated programs, any challenge may be used.

This application incorporates by reference, in their entirety, U.S. patent application Ser. No. 11/458,965, filed Jul. 20, 2006, entitled “System and Method of Securing Web Applications Against Threats”; U.S. Provisional Patent Application Ser. No. 60/807,919, filed Jul. 20, 2006, entitled “System and Method of Preventing Web Applications Threats”; U.S. patent application Ser. No. 11/532,058, filed Sep. 14, 2006, entitled “System and Method of Preventing Web Application Threats”; U.S. Provisional Patent Application Ser. No. 60/807,921, filed Jul. 20, 2006, entitled “System and Method of Securing Web Applications Across an Enterprise”; U.S. patent application Ser. No. 11/532,060, filed Sep. 14, 2006, entitled “System and Method of Securing Web Applications Across an Enterprise”; and U.S. Provisional Patent Application Ser. No. 60/988,212, filed Nov. 15, 2007, entitled “A Method and Apparatus for Detection of Information Transmission Abnormalities” In alternative embodiments the methods and systems described herein can be combined with one or more of the methods and systems described in those applications and/or can be implemented using the systems described in one or more of those applications.

While many of the examples in the present description has described preventing Web application threats, the techniques described can be used in any network, or application, to monitor and identify anomalous traffic in a network. In other words, network traffic does not have to be intended for a Web application for the techniques described to be used. In this way all network traffic, not just application traffic, can be analyzed to determine if it is acceptable traffic. For example, traffic internal to a network, such as traffic between two network users, or a network user and a network device, or any network traffic, can be monitored to determine if the conforms to acceptable user behavior.

Those of skill in the art will appreciate that the various illustrative modules, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, engines, and method steps described in connection with the embodiments disclosed herein can be implemented or performed with computer hardware including a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

What is claimed is:

1. A method for securing a web server, the method comprising:
receiving a request to access content on a web server at an application security system;
identifying a source of the request using the application security system;
incrementing a request total associated with the source representing a number of requests received from the source during a predetermined time interval;
determining whether the request total exceeds an access threshold associated with the content; and
performing a responsive action if the request total exceeds the access threshold.

2. The method of claim 1 wherein the responsive action includes blocking the request from the source to prevent the request from reaching the web server.

3. The method of claim 2 wherein the responsive action further comprises blocking subsequent requests from the source from reaching the web server.

4. The method of claim 1, further comprising:
identifying a user associated with the request; and
logging the user out from the web server if the request total exceeds the access threshold.

5. The method of claim 4, further comprising:
blocking subsequent requests received from the user.

6. The method of claim 1 wherein incrementing a request total associated with the source representing the number of requests received from the source during a predetermined time interval further comprises:
monitoring requests received from the source over a predetermined time frame, the predetermined time frame including a plurality of incremental time windows;
identifying a current incremental time window;
incrementing a request total associated with the current incremental time window;
calculating a current request total by summing a request total associated with a set of incremental time windows included in a rolling time window; and
wherein determining whether the request total exceeds an access threshold associated with the content further comprises comparing the current request total to access threshold.

7. The method of claim 1, further comprising:
identifying a security policy associated with the content, the security policy identifying the responsive action to be taken if the request total exceeds the access threshold.

8. An application security system comprising:
a processor;
a computer-readable storage medium communicatively coupled with the processor and storing computer-executable instructions comprising
an application protection module configured to perform the following steps
receiving a request to access content on a web server;
identifying a source of the request;
incrementing a request total associated with the source representing a number of requests received from the source during a predetermined time interval;
determining whether the request total exceeds an access threshold associated with the content; and
performing a responsive action if the request total exceeds the access threshold.

9. The application security system of claim 8 wherein the responsive action includes blocking the request from the source.

10. The application security system of claim 9 wherein the responsive action further comprises blocking subsequent requests from the source.

11. The application security system of claim 8, wherein the application protection module is further configured to perform the following steps:
identifying a user associated with the request; and
logging the user out from the web server if the request total exceeds the access threshold.

12. The application security system of claim 11, wherein the application protection module is further configured to perform the following steps:
blocking subsequent requests received from the user.

13. The application security system of claim 8 wherein incrementing a request total associated with the source representing the number of requests received from the source during a predetermined time interval further comprises:
monitoring requests received from the source over a predetermined time frame, the predetermined time frame including a plurality of incremental time windows;
identifying a current incremental time window;
incrementing a request total associated with the current incremental time window; and
calculating a current request total by summing a request total associated with a set of incremental time windows included in a rolling time window;
wherein determining whether the request total exceeds an access threshold associated with the content further comprises comparing the current request total to access threshold.

14. The application security system of claim 8, wherein the application protection module is further configured to perform the following steps:
identifying a security policy associated with the content, the security policy identifying the responsive action to be taken if the request total exceeds the access threshold.

15. A computer-readable medium comprising processor-executable instructions that, when executed, direct a computer system to perform actions comprising:
receiving a request to access content on a web server;
identifying a source of the request;
incrementing a request total associated with the source representing a number of requests received from the source during a predetermined time interval;
determining whether the request total exceeds an access threshold associated with the content; and
performing a responsive action if the request total exceeds the access threshold.

16. The computer-readable medium of claim 15 wherein the responsive action includes blocking the request from the source to prevent the request from reaching the web server.

17. The computer-readable medium of claim 16 wherein the responsive action further comprises blocking subsequent requests from the source from reaching the web server.

18. The computer-readable medium of claim 15, further comprising instructions that, when executed, direct the computer system to perform actions comprising:
identifying a user associated with the request; and
logging the user out from the web server if the request total exceeds the access threshold.

19. The computer-readable medium of claim 18, further comprising instructions that, when executed, direct the computer system to perform actions comprising:
blocking subsequent requests received from the user.

20. The computer-readable medium of claim 15 wherein incrementing a request total associated with the source representing the number of requests received from the source during a predetermined time interval further comprises:
monitoring requests received from the source over a predetermined time frame, the predetermined time frame including a plurality of incremental time windows;
identifying a current incremental time window;
incrementing a request total associated with the current incremental time window;
calculating a current request total by summing a request total associated with a set of incremental time windows included in a rolling time window; and
wherein determining whether the request total exceeds an access threshold associated with the content further comprises comparing the current request total to access threshold.

21. The computer-readable medium of claim 15, further comprising instructions that, when executed, direct the computer system to perform actions comprising:
identifying a security policy associated with the content, the security policy identifying the responsive action to be taken if the request total exceeds the access threshold.
